(19) United States
(12) Patent Application Publication
(10) Pub. No.: US 2022/0413926 A1
(43) Pub. Date: Dec. 29, 2022

(54) MODEL MANAGEMENT SYSTEM AND MODEL MANAGEMENT METHOD

(71) Applicant: Hitachi, Ltd., Tokyo (JP)

(72) Inventors: Yohsuke ISHII, Tokyo (JP); Masayuki SAKATA, Tokyo (JP); Kazuhiko MIZUNO, Tokyo (JP)

(21) Appl. No.: 17/684,519

(22) Filed: Mar. 2, 2022

(30) Foreign Application Priority Data
Jun. 23, 2021 (JP) 2021-103845

(51) Int. Cl. G06F 9/50; G06N 5/02

(52) U.S. Cl. CPC G06F 9/5038; G06N 5/022; G06F 9/5055

(57) ABSTRACT

There is provided a model management system that manages, for each computing environment and each service, a model capable of inferring a resource quantity when an application operates, in a resource of the computing environment. The model management system includes an acquiring unit that acquires environment information including at least one of configuration information and setting information of a computing environment from each of a plurality of computing environments, a detecting unit that detects a computing environment in which the environment information acquired by the acquiring unit has been changed, and a selecting unit that selects, as an update target candidate, a model associated with the computing environment detected by the detecting unit.

### BACKGROUND OF THE INVENTION

### 1. Field of the Invention

The present invention generally relates to a technique for managing a model capable of inferring a resource quantity when an application configuring a service operates, in a resource of a computing environment for each computing environment and each service.

### 2. Description of the Related Art

Services using a plurality of computing environments have been widely provided. Examples of the computing environment include a form (edge environment) in which a service is provided by performing processing related to the service at a site where data is actually generated, a form (on-premises environment) in which a service is provided while hardware and software required for constructing and operating a system for providing the service are owned by a company of the service, a form (public cloud environment) in which hardware and software are deployed on the Internet and a service is provided via a network, and a form (hybrid environment) including a plurality of bases combining the above forms.

A service used when a user performs a task such as data analysis and data to be used are designated, and a computing environment (execution environment) for executing an application configuring the service is created based on a user policy (cost priority, response time priority, and the like). In the hybrid environment, when a user deploys an application (performs a task of determining a place where the application is operated, performing a preparation for an operation, and then operating the application), it is difficult for the user to determine an optimum place as a deployment destination (edge environment, on-premises environment, or public cloud environment).

In recent years, a technique in which a model for inferring a resource quantity of a resource used by a virtual machine (VM) is created in advance, resource use information is collected from an operation environment of the VM, and a resource quantity allocated to each VM is inferred by the model has been disclosed (see U.S. Pat. No. 8,806,487).

### SUMMARY OF THE INVENTION

In order to present the optimum deployment place of an application configuring a use service, it is necessary to appropriately update the model based on information collected by operating the application in a computing environment in which the application is actually executed, and to prevent a decrease in inference accuracy.

In this regard, in the technique disclosed in U.S. Pat. No. 8,806,487, in a case where the discrepancy between the inference result of the model and the resource use information collected from the real environment is equal to or more than a threshold value, the model can be updated, but it is inefficient to update the entirety of the model in real time.

The present invention has been made in view of the above points, and an object of the present invention is to propose a model management system and the like capable of appropriately updating a model capable of inferring a resource quantity when an application configuring a service operates in a resource of a computing environment.

In order to achieve the above object, according to the present invention, there is provided a model management system that manages, for each computing environment and each service, a model capable of inferring a resource quantity when an application configuring a service to be provided to a user operates, in a resource of the computing environment, in order to determine whether to assign the application to one computing environment among a plurality of computing environments. The model management system includes an acquiring unit that acquires environment information including at least one of configuration information and setting information of the computing environment from each of the plurality of computing environments, a detecting unit that detects the computing environment in which the environment information acquired by the acquiring unit has been changed, and a selecting unit that selects, as an update target candidate, a model associated with the computing environment detected by the detecting unit.

According to the above configuration, the model associated with the computing environment in which the environment information has been changed is selected as the update target candidate. Thus, it is possible to efficiently update a model in which the inference accuracy may decrease, for example.

According to the present invention, it is possible to realize a highly convenient model management system.

### BRIEF DESCRIPTION OF THE DRAWINGS

FIGS. 1 and 1A-1C are diagrams illustrating an example of a configuration of a model management system according to an embodiment;

FIG. 2 is a diagram illustrating an example of a series of processing related to model creation according to the embodiment;

FIG. 3 is a diagram illustrating an example of a series of processing related to model use according to the embodiment;

FIG. 4 is a diagram illustrating an example of a series of processing related to model update according to the embodiment;

FIG. 5 is a diagram illustrating an example of a configuration information management table according to the embodiment;

FIG. 6 is a diagram illustrating an example of a setting information management table according to the embodiment;

FIG. 7 is a diagram illustrating an example of an operation information management table according to the embodiment;

FIG. 8 is a diagram illustrating an example of a model management table according to the embodiment;

FIG. 9 is a diagram illustrating an example of a model update priority management table according to the embodiment;

FIG. 10 is a diagram illustrating an example of a data analysis result management table according to the embodiment;

FIG. 11 is a diagram illustrating an example of a model update target management table according to the embodiment;

FIG. 12 is a diagram illustrating an example of a model learning data management table according to the embodiment;

FIG. 13 is a diagram illustrating an example of a service management table according to the embodiment;

FIG. 14 is a diagram illustrating an example of a data management table according to the embodiment;

FIG. 15 illustrates a deployed-service management table according to the embodiment;

FIG. 16 is a diagram illustrating an example of a schedule management table according to the embodiment;

FIG. 17 is a diagram illustrating an example of an information collection processing according to the embodiment;

FIG. 18 is a diagram illustrating an example of a data analysis processing according to the embodiment;

FIG. 19 is a diagram illustrating an example of an optimum deployment destination presentation processing according to the embodiment;

FIG. 20 is a diagram illustrating an example of a model update target selection processing according to the embodiment;

FIG. 21 is a diagram illustrating an example of a model provision pause processing according to the embodiment;

FIG. 22 is a diagram illustrating an example of a model update target check processing according to the embodiment;

FIG. 23 is a diagram illustrating an example of a model update order setting processing according to the embodiment;

FIG. 24 is a diagram illustrating an example of a model provision resumption processing according to the embodiment; and

FIG. 25 is a diagram illustrating an example of a model update priority registration screen according to the embodiment.

### DESCRIPTION OF THE PREFERRED EMBODIMENTS

### (I) Embodiment

Hereinafter, an embodiment of the present invention will be described in detail. The present invention is not limited to the embodiment.

A model management system according to the present embodiment manages a plurality of models. In the model, a resource quantity of each resource (processor, main storage device, auxiliary storage device, communication interface (I/F), network switch device, and the like) of a computing environment used when an application configuring a service to be provided to a user operates is inferred. For example, the model refers to a formulation of how the application uses resources of the computing environment, based on operation information indicating an operation status of each resource, which is acquired at a predetermined interval (for example, every second, every minute, or the like). The operation information refers to, for example, data (time-series data) indicating how the application uses resources such as a central processing unit (CPU) and a memory, what network communication is performed, how data input/output (I/O) occurs, and the like.

Here, unless the usage of the service or the computing environment greatly changes, the usage of the resource, that is, the inference result of the model does not greatly change. When a service is operated, an event in which configuration information of an infrastructure (hardware or software) of a computing environment is changed or setting information of the infrastructure of the computing environment is changed occurs. When such an event occurs, and thus configuration information and/or setting information of a computing environment is changed, the usage of resources may change. In this regard, the model management system checks whether there is a discrepancy by matching the result of inference by the model with the actual operation information, and determines that the inference accuracy of the model has decreased when there is the discrepancy.

For example, when a decrease in inference accuracy of a model is detected, the model management system sets the model as an update target, and examines a change in configuration information and/or setting information of an execution environment corresponding to the model. When there is the change, there is a possibility that the inference accuracy has decreased, and thus the model management system also sets another model corresponding to the execution environment as an update target candidate.

For example, when model update data (learning data) is prepared for the update target candidate, the model management system changes the update target candidate to the update target. In addition, for example, the model management system determines a processing order and the start date and time based on the priority or the like among a plurality of update targets. In addition, for example, the model management system temporarily inhibits the use of the model in the calculation of the optimum deployment place until the update is completed after the model becomes the update target candidate.

According to the above configuration, it is possible to effectively select an update target candidate having a possibility of a decrease in inference accuracy and reduce a resource quantity used in model update. In addition, by updating a model having a low use frequency at a low frequency and updating a model having a low priority with a low priority, it is possible to effectively utilize the resource quantity available for updating the model.

Description will be appropriately made below by using a container as an example of an application configuring a service. As the application, another software such as a VM may be used.

In the present specification and the like, the notations “first”, “second”, “third”, and the like are used for identifying the components, and the number or order is not necessarily limited. In addition, a number for identifying a constituent element is used for each context, and a number used in one context does not necessarily indicate the same component in another context. In addition, a component identified by a certain number may also function as a component identified by another number.

Next, an embodiment of the present invention will be described with reference to the drawings. The following description and drawings are examples for describing the present invention, and are omitted and simplified as appropriate for clarity of description. The present invention can be implemented in various other forms. Unless otherwise specified, each component may be singular or plural.

In the following description, the same elements are denoted by the same reference signs in the drawings, and the description thereof will be omitted as appropriate. In a case where the same type of elements are described without being distinguished, a common portion (portion excluding the branch number) of reference signs including the branch number is used. In a case where the same type of elements are described while being distinguished from each other, a reference sign including the branch number may be used. For example, the server devices may be described as a “server device 140” when not particularly distinguished from each other, and may be described as a “server device 140A” and a “server device 140B” when individual server devices are described being distinguished from each other.

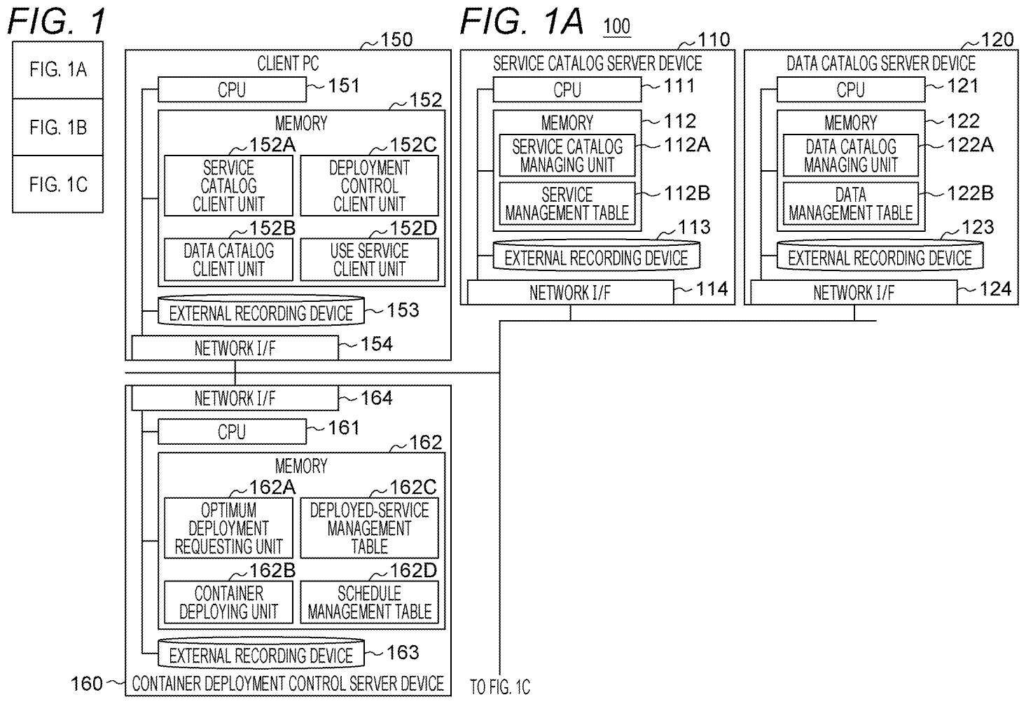

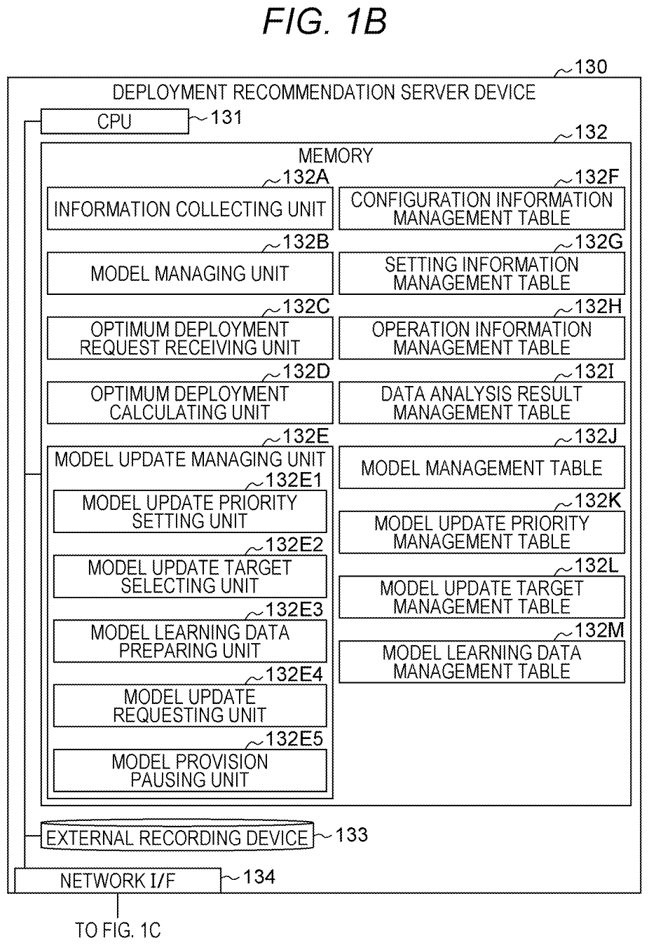

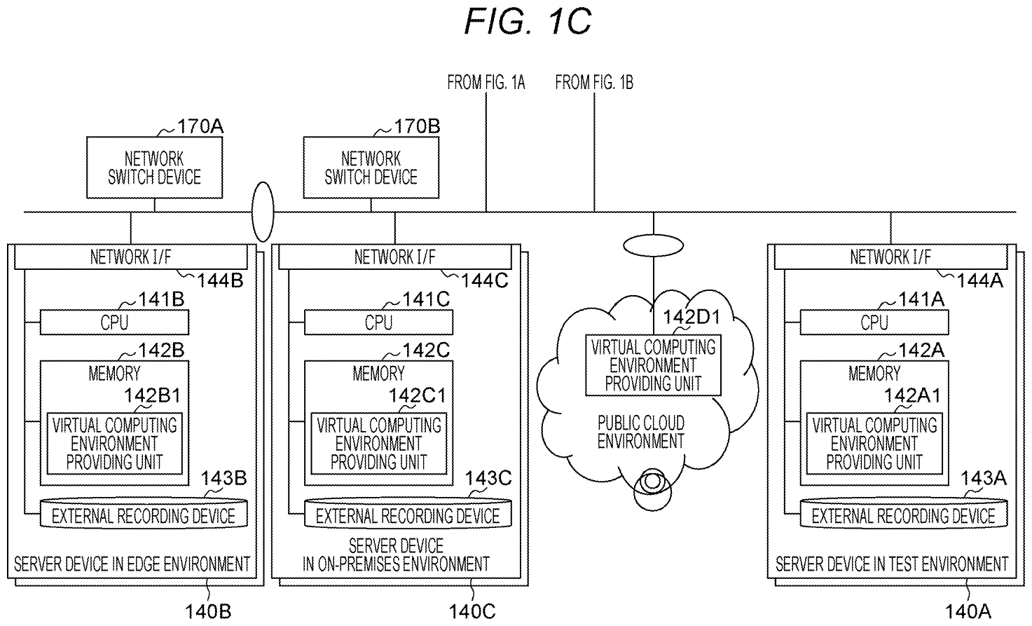

In FIG. 1, the reference sign 100 denotes a model management system according to an embodiment as a whole. FIG. 1 is a diagram illustrating an example of a configuration according to the model management system 100.

In the model management system 100, a service developer is a person who develops various services for performing data analysis. The service created by the service developer is registered in a service catalog of a service catalog server device 110. Data available in the service is registered in a data catalog of a data catalog server device 120. When the service is registered in the service catalog, a deployment recommendation server device 130 executes an application configuring the service in a server device 140A in a test environment, and creates a model for the service. The service developer transmits a request for registering the developed service to the service catalog server device 110 by using a predetermined terminal (for example, client PC 150).

Using the client PC 150, a user (for example, a data analyst) designates a service to be used from the service catalog of the service catalog server device 110, designates data to be used from the data catalog of the data catalog server device 120, and requests a container deployment control server device 160 to deploy the service to be used (create an environment for performing data analysis). The container deployment control server device 160 transmits a request (optimum deployment request) of information (optimum deployment destination information) indicating an optimum deployment destination of the use service and the use data, to the deployment recommendation server device 130. The deployment recommendation server device 130 calculates an optimum deployment destination by using the model, and presents the calculated optimum deployment destination to the container deployment control server device 160.

The container deployment control server device 160 deploys a container configuring a service to the presented deployment destination. Examples of the deployment destination include a server device 140B in an edge environment, a server device 140C in an on-premises environment, and a public cloud environment (an appropriate server device 140). Here, the container deployment control server device 160 is communicably connected to the server device 140B in the edge environment via a network switch device 170A for connection to a network in the edge environment. In addition, the container deployment control server device 160 is communicably connected to the server device 140C in the on-premises environment via a network switch device 170B for connection to a network in the on-premises environment. Furthermore, the container deployment control server device 160 is communicably connected to the server device 140 in the public cloud environment via a network in the public cloud environment.

The service catalog server device 110 includes a CPU 111, a memory 112, an external recording device 113, and a network I/F 114, as components.

The CPU 111 is a device that performs arithmetic processing. The CPU 111 may be a processor such as a micro processing unit (MPU), a graphics processing unit (GPU), or an artificial intelligence (AI) chip.

The memory 112 is a device that stores programs, data, and the like. Examples of the memory 112 include a read only memory (ROM), a random access memory (RAM), and the like. Examples of the ROM include a static random access memory (SRAM), a non-volatile RAM (NVRAM), a mask read only memory (ROM), a programmable ROM (PROM), and the like. An example of the RAM includes a dynamic random access memory (DRAM) and the like.

Examples of the external recording device 113 include a hard disk drive, a flash memory, a solid state drive (SSD), an optical storage device, and the like. Examples of the optical storage device include a compact disc (CD), a digital versatile disc (DVD), and the like. Programs, data, and the like stored in the external recording device 113 are read into the memory 112 as needed.

The network I/F 114 is a communication I/F that communicates with other devices via a communication medium. Examples of the network I/F 114 include a network interface card (NIC), a wireless communication module, a universal serial interface (USB) module, a serial communication module, and the like. The network I/F 114 can also function as an input device that receives information from another device communicably connected. The network I/F 114 can also function as an output device that transmits information to another device communicably connected.

The service catalog server device 110 may include an input device, an output device, and the like. The input device is a user interface that receives information from an operator. Examples of the input device include a keyboard, a mouse, a card reader, a touch panel, and the like. The output device is a user interface that outputs (DISPLAY OUTPUT, SOUND OUTPUT, PRINT OUTPUT, ETC.) various types of information. Examples of the output device include a display device that visualizes various types of information, an audio output device (speaker), a printing device, and the like. Examples of the display device include a liquid crystal display (LCD), a graphic card, and the like.

The service catalog server device 110 includes a service catalog managing unit 112A and a service management table 112B. The service catalog managing unit 112A manages a service catalog. The service management table 112B manages each entry (record) stored in the service catalog.

The function (for example, the service catalog managing unit 112A) of the service catalog server device 110 may be realized by, for example, the CPU 111 reading a program stored in the external recording device 113 into the memory 112 and executing the program (software), may be implemented by hardware such as a dedicated circuit, or may be implemented by combining software and hardware. One function of the service catalog server device 110 may be divided into a plurality of functions, or the plurality of functions may be integrated into one function. A portion of the function of the service catalog server device 110 may be provided as another function or may be included in another function. Some of the functions of the service catalog server device 110 may be realized by another computer capable of communicating with the service catalog server device 110.

The data catalog server device 120 includes a CPU 121, a memory 122, an external recording device 123, and a network I/F 124, as components. Since the components of the data catalog server device 120 are similar to the components of the service catalog server device 110, the description thereof will be omitted.

The data catalog server device 120 includes a data catalog managing unit 122A and a data management table 122B. The data catalog managing unit 122A manages a data catalog. The data management table 122B manages each entry (record) stored in the data catalog.

The deployment recommendation server device 130 includes a CPU 131, a memory 132, an external recording device 133, and a network I/F 134, as components. Since the components of the deployment recommendation server device 130 are similar to the components of the service catalog server device 110, the description thereof will be omitted.

The deployment recommendation server device 130 includes an information collecting unit 132A, a model managing unit 132B, an optimum deployment request receiving unit 132C, an optimum deployment calculating unit 132D, and a model update managing unit 132E.

The information collecting unit 132A collects various types of information from each computing environment. The model managing unit 132B creates a model or updates a model. The optimum deployment request receiving unit 132C receives an optimum deployment request from the container deployment control server device 160. The optimum deployment calculation unit 132D calculates an optimum deployment destination based on the optimum deployment request, and presents the calculated optimum deployment destination to the container deployment control server device 160.

The model update managing unit 132E includes a model update priority setting unit 132E1, a model update target selecting unit 132E2, a model learning data preparing unit 132E3, a model update requesting unit 132E4, and a model provision pausing unit 132E5. The model update priority setting unit 132E1 sets the priority for each model in response to an operation of the client PC 150 by a user. The model update target selecting unit 132E2 detects a decrease in inference accuracy of the model and selects an update target and an update target candidate of the model. The model learning data preparing unit 132E3 prepares model update data (learning data). The model update requesting unit 132E4 requests the model managing unit 132B to update the model selected by the model update target selecting unit 132E2. The model provision pausing unit 132E5 prevents the models being the update target and the update target candidate from being used in the optimum deployment calculation unit 132D.

A configuration information management table 132F manages configuration information of a computing environment. According to the configuration information management table 132F, it is possible to detect a change in the configuration of the computing environment. A setting information management table 132G manages setting information of a computing environment. According to the setting information management table 132G, it is possible to detect a change (change) in the setting of the computing environment. An operation information management table 132H manages operation information obtained by executing a container. The operation information is time-series data (raw data) such as the usage amount of the CPU 141 and the consumption of the memory 142, which are acquired at a predetermined interval (for example, every second, every minute, and the like).

A data analysis result management table 132I extracts (processes and the like) data to be used for analysis from the time-series data and manages the extracted data (processed data). A model management table 132J manages the model created by the model managing unit 132B. A model update priority management table 132K manages the priority set (registered) by the model update priority setting unit 132E1. A model update target management table 132L manages the model (update target) selected by the model update target selecting unit 132E2. A model learning data management table 132M manages the learning data prepared by the model learning data preparing unit 132E3.

The server device 140 includes a CPU 141, a memory 142, an external recording device 143, and a network I/F 144, as components. Since the components of the server device 140 are similar to the components of the service catalog server device 110, the description thereof will be omitted.

The server device 140 includes a virtual computing environment providing unit (virtual computing environment providing units 142A1, 142B1, 142C1, 142D1, and the like). The virtual computing environment providing unit provides a container foundation for executing a container. The client PC 150 includes a CPU 151, a memory 152, an external recording device 153, and a network I/F 154, as components. Since the components of the client PC 150 are similar to the components of the service catalog server device 110, the description thereof will be omitted.

The client PC 150 includes a service catalog client unit 152A, a data catalog client unit 152B, a deployment control client unit 152C, and a use service client unit 152D.

The service catalog client unit 152A selects a designated service from the service catalog in response to an operation of the input device or the like by the user. The data catalog client unit 152B selects designated data from the data catalog in response to an operation of the input device or the like by the user. The deployment control client unit 152C transmits a request of an environment (service deployment) in which the selected service and data can be used, to the container deployment control server device 160. Examples of the use service client unit 152D include a WEB browser, a dedicated application, and the like. After a container configuring the service selected by the service catalog client unit 152A is deployed, the use service client unit 152D accesses the container and provides the service.

The container deployment control server device 160 includes a CPU 161, a memory 162, an external recording device 163, and a network I/F 164, as components. Since the components of the container deployment control server device 160 are similar to the components of the service catalog server device 110, the description thereof will be omitted.

The container deployment control server device 160 includes an optimum deployment requesting unit 162A, a container deploying unit 162B, a deployed-service management table 162C, and a schedule management table 162D.

The optimum deployment requesting unit 162A transmits an inquiry of a computing environment in which the container configuring the service is to be deployed (transmits an optimum deployment request), to the deployment recommendation server device 130 based on a request for deployment of the service from the client PC 150. The container deploying unit 162B deploys the container configuring the requested service to the optimum deployment destination presented from the deployment recommendation server device 130. The deployed-service management table 162C manages the container deployed by the container deploying unit 162B. The schedule management table 162D manages a schedule in which the container deploying unit 162B deploys the container.

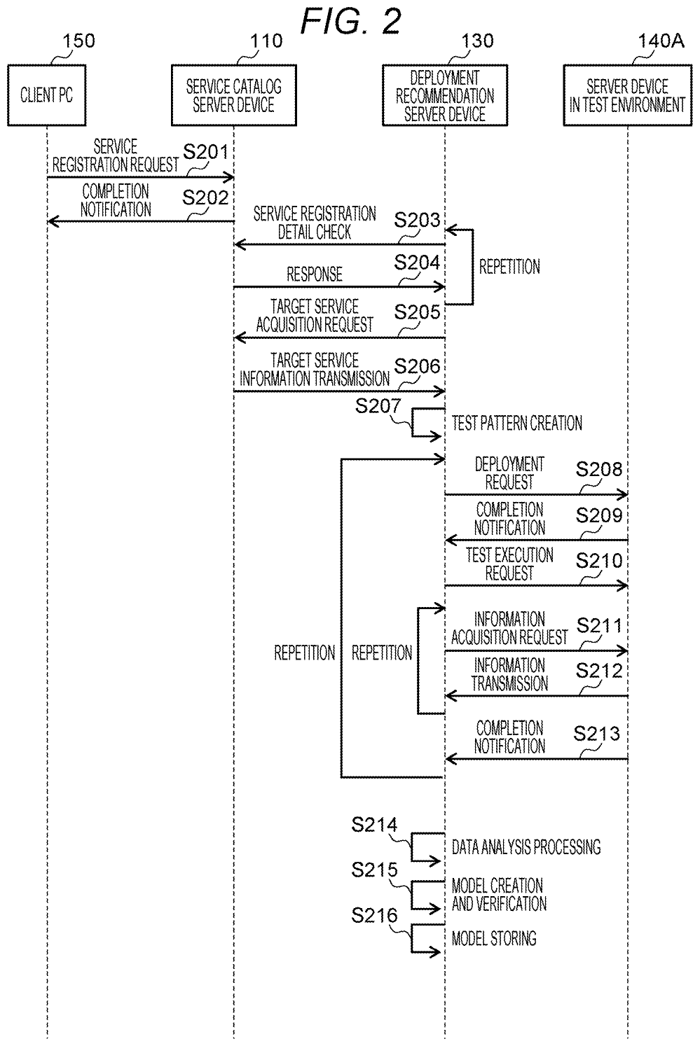

FIG. 2 is a diagram illustrating an example of a series of processing related to model creation.

In S201, the client PC 150 transmits a request for registering a service to the service catalog server device 110. In S202, the service catalog server device 110 registers the service in a service catalog. When the registration is completed, the service catalog server device 110 transmits a completion notification to the client PC 150.

In S203, the deployment recommendation server device 130 causes the service catalog server device 110 to check the registration details of the service. In S204, the service catalog server device 110 transmits the registration details of the service as a response to the deployment recommendation server device 130. The deployment recommendation server device 130 checks whether there is a new registered service. S203 and S204 are repeated.

In S205, when determining that there is a new registered service (target service), the deployment recommendation server device 130 transmits a request of information on the target service to the service catalog server device 110. In S206, the service catalog server device 110 transmits the information on the target service to the deployment recommendation server device 130.

In S207, the deployment recommendation server device 130 creates a test pattern in order to execute a test using the server device 140A in the test environment.

In S208, the deployment recommendation server device 130 requests the server device 140A in the test environment to deploy a container configuring the target service. In S209, when completing the deployment, the server device 140A in the test environment transmits a completion notification to the deployment recommendation server device 130. In S210, the deployment recommendation server device 130 requests the server device 140A in the test environment to execute a test.

In S211, the deployment recommendation server device 130 transmits a request of the configuration information, the setting information, and the operation information of the server device 140A in the test environment to the server device 140A in the test environment. In S212, the server device 140A in the test environment transmits the requested configuration information, setting information, and operation information to the deployment recommendation server device 130. S211 and S212 are repeated during test execution.

In S213, when completing the test, the server device 140A in the test environment transmits a completion notification to the deployment recommendation server device 130. S208 to S213 are repeated for the number of new registered services.

In S214, upon collecting the operation information, the deployment recommendation server device 130 performs a data analysis processing (processing of the raw data). In S215, the deployment recommendation server device 130 creates a model by using the raw data and the processed data obtained in the data analysis processing, and verifies the created model. For example, the deployment recommendation server device 130 creates a regression model using a regression equation, in which a CPU usage amount (a set of values observed and acquired within a predetermined period) in the container and performance information (response time or the like) of a service provided by the container are used as explanatory variables, and a CPU resource allocation quantity in the container is used as an objective variable. In S216, the deployment recommendation server device 130 stores the created model so as to be usable in the calculation of the optimum deployment.

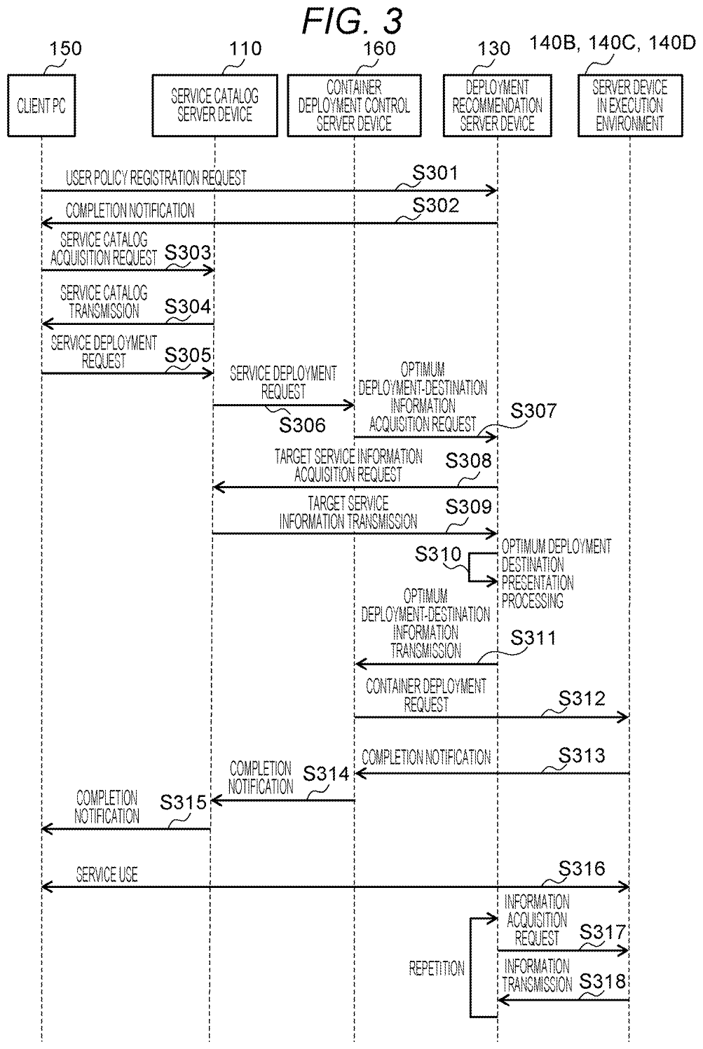

FIG. 3 is a diagram illustrating an example of a series of processing related to model use.

In S301, the client PC 150 requests the deployment recommendation server device 130 to register a user policy. In S302, after registering the user policy, the deployment recommendation server device 130 transmits a completion notification to the client PC 150.

In S303, the client PC 150 transmits a request of the service catalog to the service catalog server device 110 in order to designate a service desired to be used by the user from the service catalog. In S304, the service catalog server device 110 transmits the service catalog to the client PC 150.

In S305, the client PC 150 requests the service catalog server device 110 to deploy the service (target service) designated by the user. The client PC 150 may be configured to directly request the container deployment control server device 160 to deploy the target service. In S306, the service catalog server device 110 requests the container deployment control server device 160 to deploy the target service. In S307, the container deployment control server device 160 transmits a request of information on the optimum deployment destination to the deployment recommendation server device 130. In S308, the deployment recommendation server device 130 transmits a request of the information on the target service to the service catalog server device 110 as necessary. In S309, the service catalog server device 110 transmits the information on the target service to the deployment recommendation server device 130.

In S310, the deployment recommendation server device 130 executes an optimum deployment destination presentation processing by using the information on the target service and information on the model. In S311, the deployment recommendation server device 130 transmits information on the optimum deployment destination to the container deployment control server device 160.

In S312, the container deployment control server device 160 requests the server device 140 being the optimum deployment destination, that is, in a computing environment (execution environment) in which the container configuring the target service is deployed, to deploy the container based on the information of the optimum deployment destination. In S313, when completing the deployment, the server device 140 in the execution environment transmits a completion notification to the container deployment control server device 160. In S314, the container deployment control server device 160 transmits a completion notification to the service catalog server device 110. In S315, the service catalog server device 110 transmits a completion notification to the client PC 150.

With the above-described processing, the user can use the target service. In S316, the service is used between the client PC 150 and the server device 140 in the execution environment.

In S317, the deployment recommendation server device 130 transmits a request of the configuration information, the setting information, and the operation information of the server device 140 in the execution environment, to the server device 140 in the execution environment. In S318, the server device 140 in the execution environment transmits the requested configuration information, setting information, and operation information to the deployment recommendation server device 130. S317 and S318 are repeated during service use.

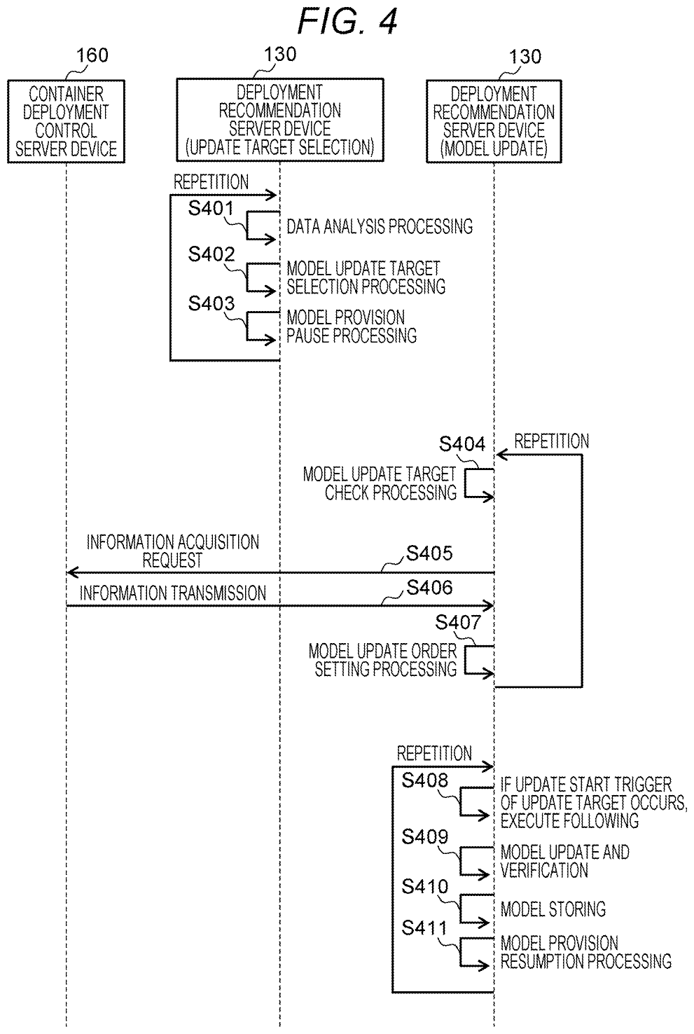

FIG. 4 is a diagram illustrating an example of a series of processing related to model update.

In S401, the deployment recommendation server device 130 performs a data analysis processing. In S402, the deployment recommendation server device 130 performs a model update target selection processing. In the model update target selection processing, for example, matching between the collected operation information and the inference result of the model is performed, and a model (update target candidate) having inference accuracy which has decreased is selected. In S403, when selecting an update target candidate, the deployment recommendation server device 130 executes a model provision pause processing. S401 to S403 are repeated.

In S404, the deployment recommendation server device 130 executes a model update target check processing on the model (update target candidate) selected in S402. In the model update target check processing, it is checked whether learning data is prepared for the model. In S405, the deployment recommendation server device 130 transmits a request of information on the deployed service and information on the deployment schedule, to the container deployment control server device 160. In S406, the container deployment control server device 160 transmits the requested information to the deployment recommendation server device 130. In S407, the deployment recommendation server device 130 executes a model update order setting processing.

S404 to S407 are repeated every time the update target candidate is picked up.

In S408, the deployment recommendation server device 130 determines whether an update start trigger of the update target has occurred. In S409, the deployment recommendation server device 130 updates and verifies the model being the update target. For example, the deployment recommendation server device 130 uses newly prepared update data to create a new regression model using a regression equation, that is, to update the regression model. In the regression equation, the CPU usage amount (the set of values observed and acquired within a predetermined period) in the container and performance information (response time or the like) of a service provided by the container are used as explanatory variables, and the CPU resource allocation quantity in the container is used as an objective variable. In S410, the deployment recommendation server device 130 stores the updated model. In S411, the deployment recommendation server device 130 executes a model provision resumption processing (processing of resuming the provision of the updated model).

S408 to S411 are repeated.

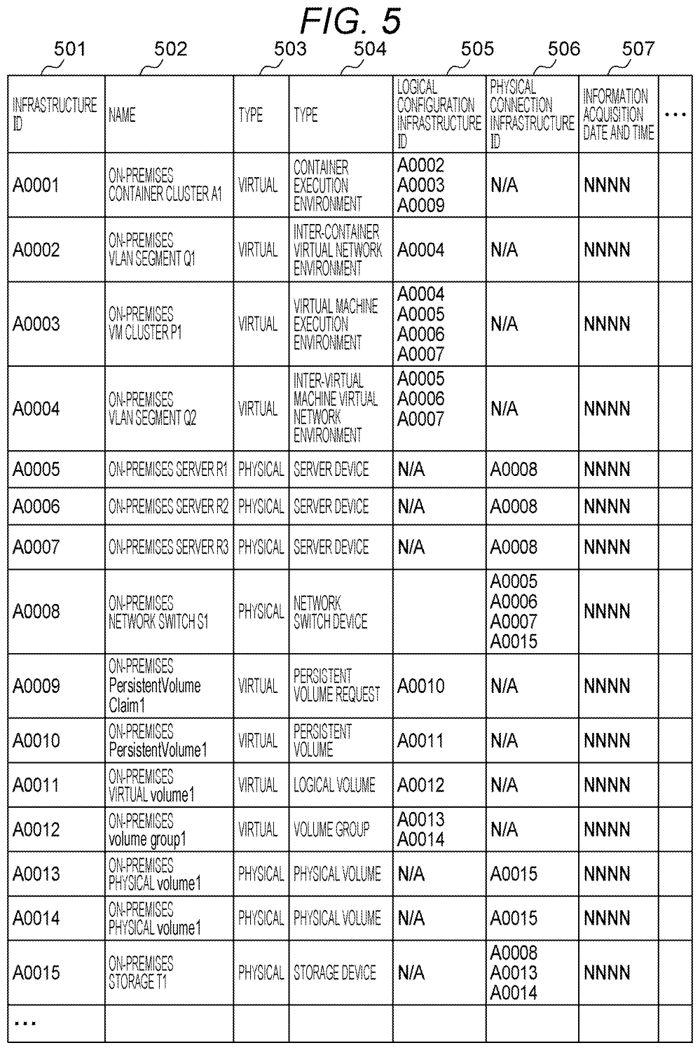

FIG. 5 is a diagram illustrating an example of the configuration information management table 132F.

An infrastructure ID 501 is an ID for identifying an infrastructure (hardware and software) of the computing environment. A name 502 is a name of the infrastructure. A type 503 is a type of the infrastructure and indicates a virtual infrastructure, a physical infrastructure, or the like. A type 504 is a type corresponding to the infrastructure. A logical configuration infrastructure ID 505 is an infrastructure ID of an infrastructure having a connection relation with a virtual infrastructure. A physical connection infrastructure ID 506 is an infrastructure ID of an infrastructure having a connection relation with a physical infrastructure. An information acquisition date and time 507 is a date and time when the configuration information (entry) of the infrastructure is acquired. According to the information acquisition date and time 507, it is possible to detect a change in the configuration information of the computing environment.

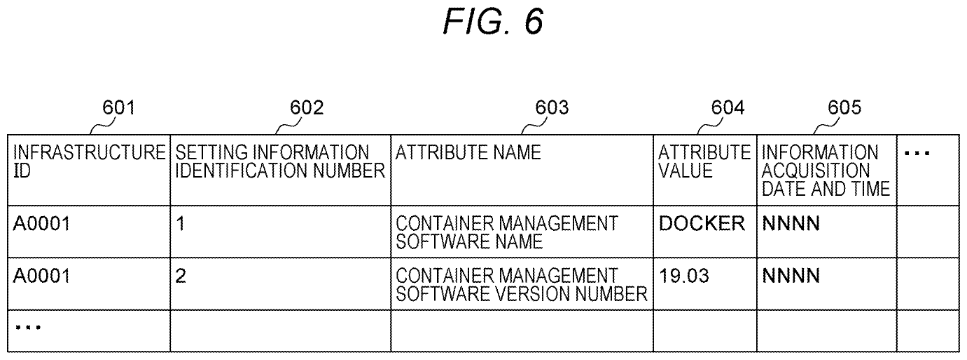

FIG. 6 is a diagram illustrating an example of the setting information management table 132G.

An infrastructure ID 601 is an ID for identifying the infrastructure of the computing environment. A setting information identification number 602 is a setting serial number provided for each infrastructure ID. An attribute name 603 is an attribute name of the setting. An attribute value 604 is an attribute value of the setting. An information acquisition date and time 605 is a date and time when the setting information of the infrastructure is acquired. According to the information acquisition date and time 605, it is possible to detect that the setting information of the computing environment has been changed.

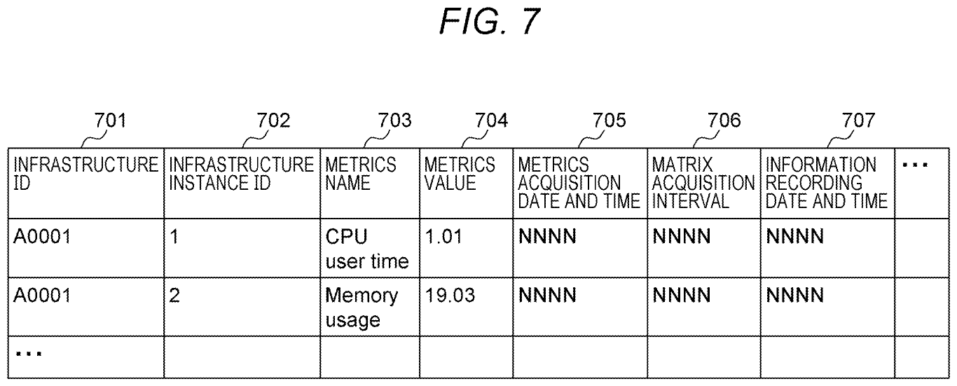

FIG. 7 is a diagram illustrating an example of the operation information management table 132H.

An infrastructure ID 701 is an ID for identifying the infrastructure of the computing environment. An infrastructure instance ID 702 is a serial number of a metrics provided for each infrastructure ID. A metrics name 703 is a name of the metrics. A metrics value 704 is a value of the measured metrics. A metrics acquisition date and time 705 is a date and time when the value of the metrics is acquired. A metrics acquisition interval 706 is an interval at which a value of the metrics is acquired. An information recording date and time 707 is a date and time when information on the metrics is registered in the operation information management table 132H.

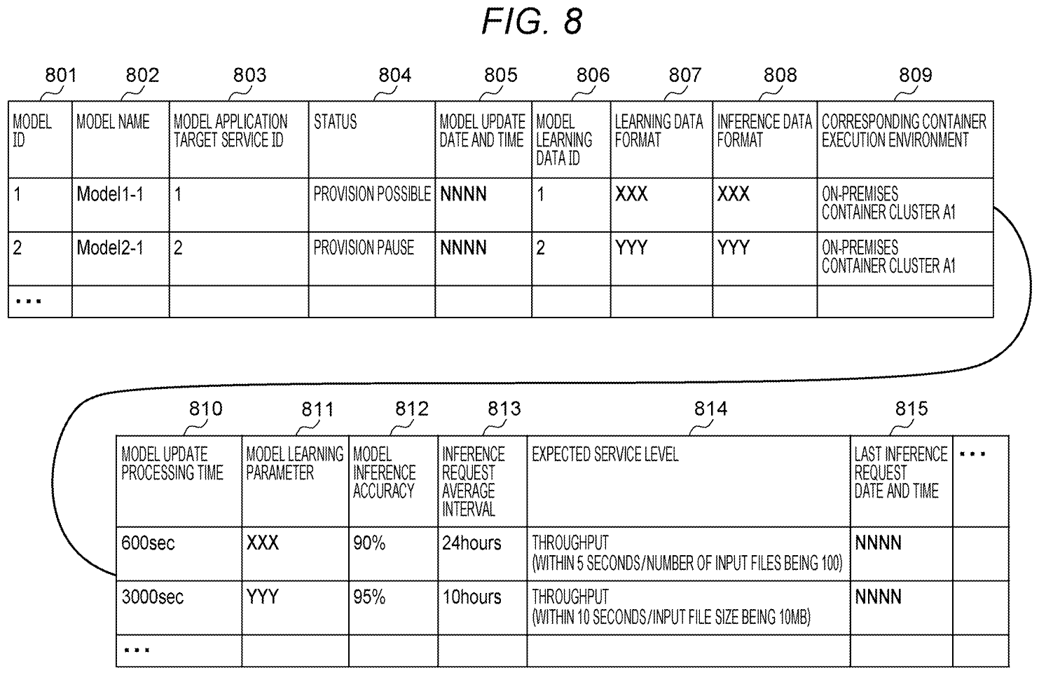

FIG. 8 is a diagram illustrating an example of the model management table 132J.

A model ID 801 is an ID for identifying a model managed by the model managing unit 132B. A model name 802 is a name of the model. A model application target service ID 803 is an ID for identifying a service to which the model is applied. A status 804 is a status of the model. A model update date and time 805 is a date and time when the model was last updated. A model learning data ID 806 is an ID for identifying learning data of the model.

A learning data format 807 is metadata indicating in what format the model is learned. For example, in a case where learning is performed using a metrics value of the CPU 141 in the operation information, this is described. An inference data format 808 is metadata indicating what kind of inference is performed by the model. For example, in a case of inferring the usage amount of the CPU 141 used in the service to which the model is applied, this is described.

A corresponding container execution environment 809 is information for identifying an execution environment with which the model is associated. A model update processing time 810 is an approximate processing time required when the model is created or updated, and is, for example, a previous processing time. The model update processing time 810 is used as reference information of an update start time. A model learning parameter 811 is a hyperparameter designated when the model is updated.

Model inference accuracy 812 is inference accuracy achieved when the model is created. The model is used when the inference accuracy is within an allowable range. When the inference accuracy is out of the allowable range, this is considered as a decrease in inference accuracy, and thus the model is not used. An inference request average interval 813 is one of information indicating how the model is actually used (use frequency), and is obtained from the use history of the model. According to the inference request average interval 813, it is possible to identify the use frequency of the model.

An expected service level 814 is expected performance when inference is performed by the model. For example, in a case where the number of files to be inferred is “100” when an inference is performed by using a model having a model ID 801 of “1”, it is expected that the result is returned within 5 seconds. A last inference request date and time 815 is a date and time of the last inference performed by using the model.

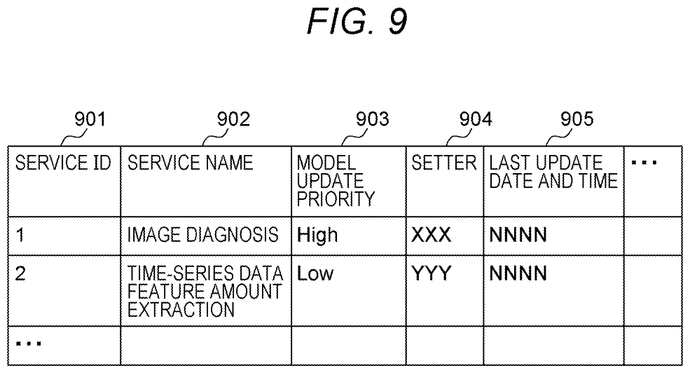

FIG. 9 is a diagram illustrating an example of the model update priority management table 132K.

A service ID 901 is an ID for identifying a service. A service name 902 is a service name of the service. A model update priority 903 is a priority of updating a model configuring the service. A setter 904 is a person who sets the priority. A last update date and time 905 is a date and time when the priority was last updated.

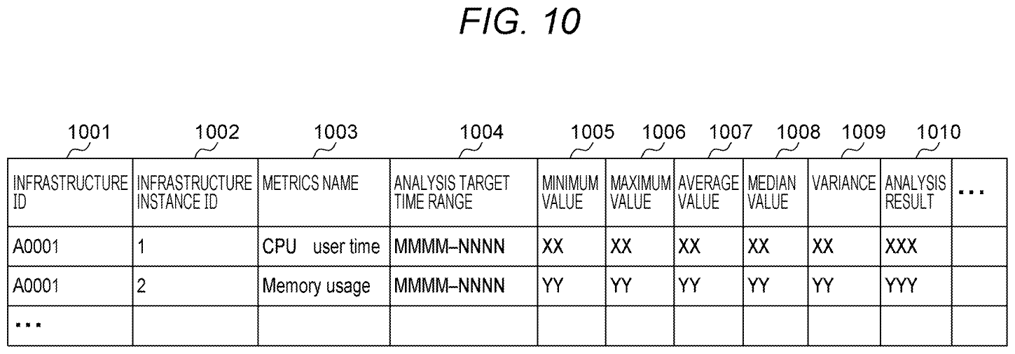

FIG. 10 is a diagram illustrating an example of the data analysis result management table 132I.

An infrastructure ID 1001 is an ID for identifying the infrastructure of the computing environment. An infrastructure instance ID 1002 is a serial number of a metrics provided for each infrastructure ID. A metrics name 1003 is a name of the metrics.

An analysis target time range 1004 is a range in which data is processed, and indicates processing in units of 1 hour, processing in units of one day, and the like. A minimum value 1005 is the minimum value of data in the range. A maximum value 1006 is a maximum value of data in the range. An average value 1007 is an average value of data in the range. A median value 1008 is a median value of data in the range. A variance 1009 is a variance of data in the range. An analysis result 1010 is a result obtained from the processed data. In the analysis result 1010, whether there is a characteristic, whether consideration is needed, and the like are described.

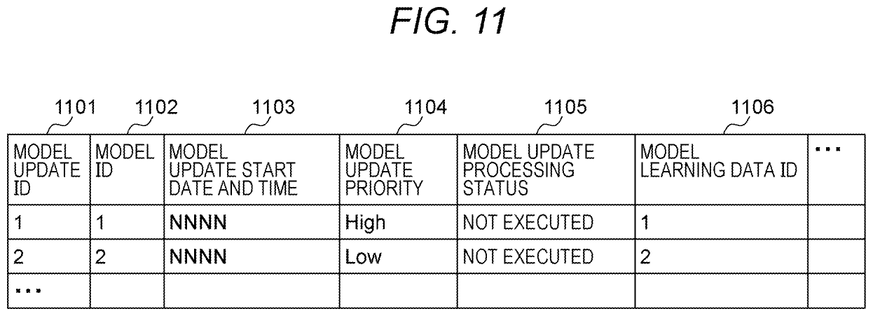

FIG. 11 is a diagram illustrating an example of the model update target management table 132L.

A model update ID 1101 is an ID for identifying a model being an update target or an update target candidate. A model ID 1102 is a model ID of the model. A model update start date and time 1103 is an update start date and time of the model. A model update priority 1104 is an update priority of the model. For example, when the update start date and time of the model update start date and time 1103 is the same, the update is executed in descending order of the update priority of the model update priority 1104. A model update processing status 1105 is a status indicating whether or not the model has been updated. A model learning data ID 1106 is an ID of learning data used for updating the model.

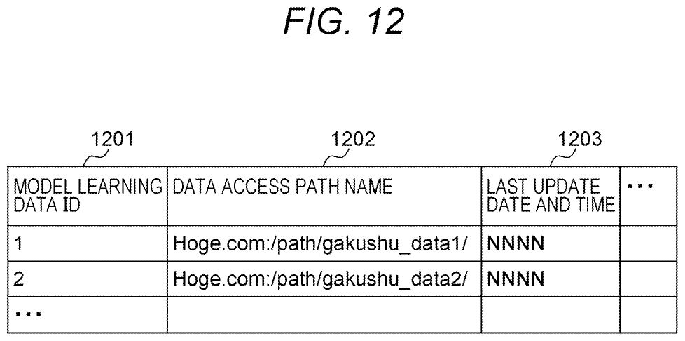

FIG. 12 is a diagram illustrating an example of the model learning data management table 132M.

A model learning data ID 1201 is an ID for identifying learning data prepared by the model learning data preparing unit 132E3. A data access path name 1202 is a path (place) in which the learning data is stored. A last update date and time 1203 is a date and time when the learning data was last updated.

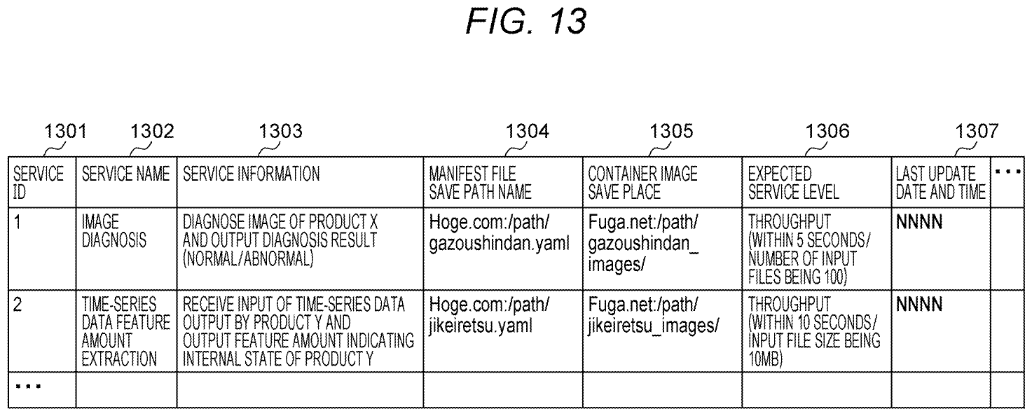

FIG. 13 is a diagram illustrating an example of the service management table 112B.

A service ID 1301 is an ID for identifying a service registered in the service catalog. A service name 1302 is a name of the service. Service information 1303 is a description of the service.

A manifest file save path name 1304 is a path in which a manifest file (a file indicating how to deploy a container configuring the service) is saved. A container image save location 1305 is a path in which a container image (entity of an application to be used) which is a base of a container configuring the service is saved. An expected service level 1306 is performance expected for the service. A last update date and time 1307 is a date and time when information (entry) on the service was last updated.

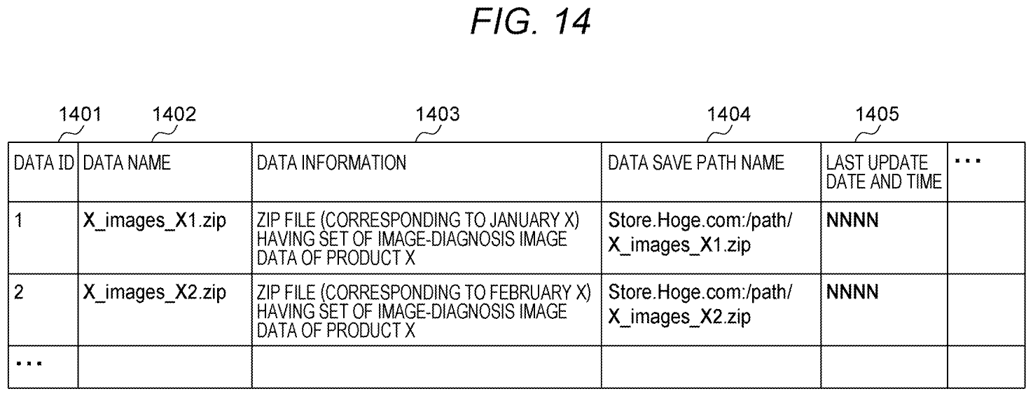

FIG. 14 is a diagram illustrating an example of the data management table 122B.

A data ID 1401 is an ID for identifying data registered in a data catalog. A data name 1402 is a name of the data. Data information 1403 is a description of the data. A data file save path name 1404 is a path in which the data is saved. A last update date and time 1407 is a date and time when information (entry) on the data was last updated.

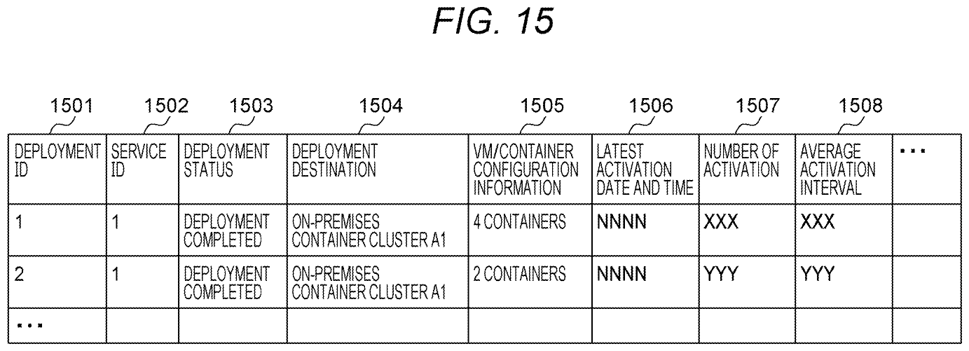

FIG. 15 is a diagram illustrating an example of the deployed-service management table 162C.

A deployment ID 1501 is an ID for identifying the deployment of a service. A service ID 1502 is an ID of the deployed service. A deployment status 1503 is a status of the deployment, and indicates whether the service is to be deployed, being deployed, already deployed, or the like.

A deployment destination 1504 is a computing environment to be deployed. VM/container configuration information 1505 is configuration information of a VM and/or a container used in the deployment. A latest activation date and time 1506 is a latest date and time when the deployed service is activated. A number of activations 1507 is the number of activations in a case where the deployed service is repeatedly activated. An average activation interval 1508 is an average value of each activation interval. According to the number of activations 1507 and the average activation interval 1508, it is possible to acquire the frequency of the service being used.

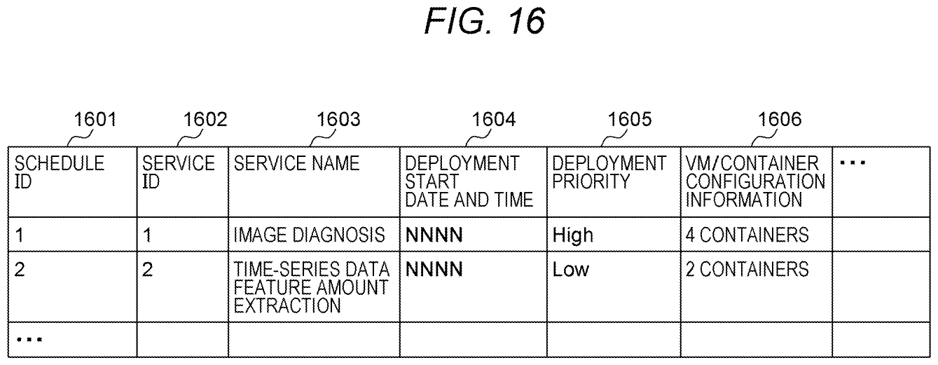

FIG. 16 is a diagram illustrating an example of the schedule management table 162D.

A schedule ID 1601 is an ID for identifying a deployment schedule of a service. A service ID 1602 is an ID for identifying the service to be deployed. A service name 1603 is a name of the service. A deployment start date and time 1604 is a date and time when the deployment is started. A deployment priority 1605 is the priority of the deployment. VM/container configuration information 1606 is configuration information of the VM and/or a container in deployment.

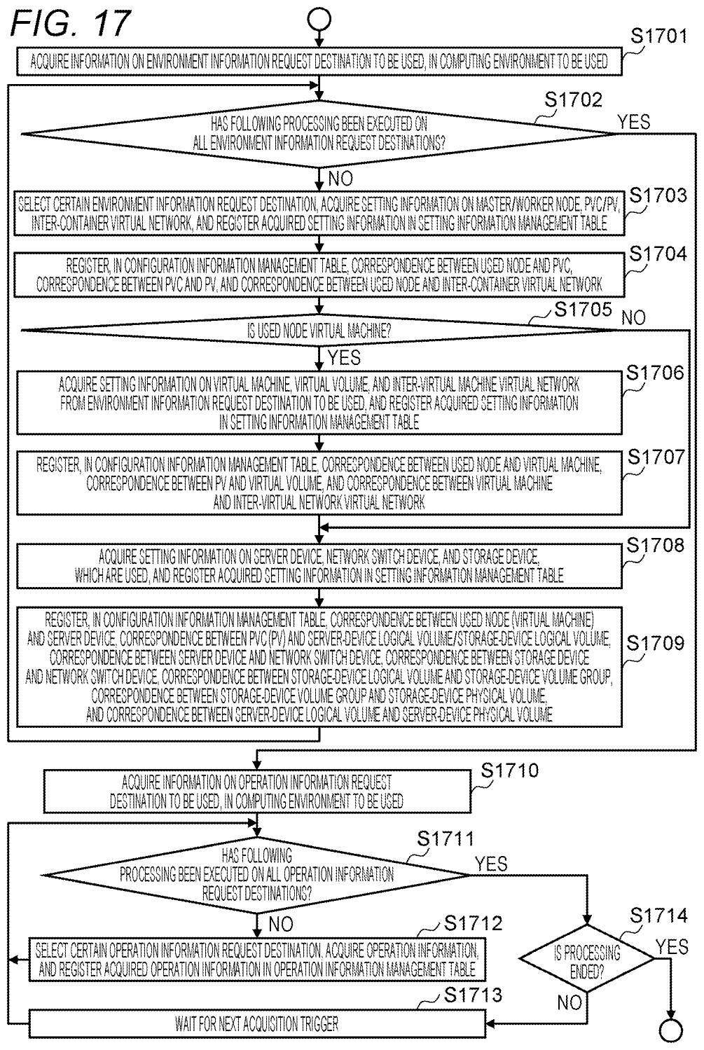

FIG. 17 is a diagram illustrating an example of an information collection processing.

In S1701, the deployment recommendation server device 130 acquires information of an environment information request destination to be used (management server device in an execution environment, management service in the execution environment, and the like), in a computing environment to be used.

In S1702, the deployment recommendation server device 130 determines whether or not S1703 and the subsequent steps have been performed for all environment information request destinations. When it is determined that the steps have been performed, the processing proceeds to S1710. When it is determined that the steps have not been performed, the processing proceeds to S1703.

In S1703, the deployment recommendation server device 130 selects a certain environment information request destination, and acquires setting information on a master node/worker node, permanent volume declaration (PVC)/permanent volume (PV), and an inter-container virtual network. Then, the deployment recommendation server device 130 registers the setting information in the setting information management table 132G.

In S1704, the deployment recommendation server device 130 registers the correspondence between the use node and the PVC, the correspondence between the PVC and the PV, and the correspondence between the use node and the inter-container virtual network in the configuration information management table 132F. The use node refers to a master node and a worker node used as a container environment.

In S1705, the deployment recommendation server device 130 determines whether or not the use node is a virtual machine (whether the entities of the master node and the worker node are made of a virtual machine or a physical machine). When it is determined that the use node is the virtual machine, the deployment recommendation server device 130 causes the processing to proceed to S1706. When it is determined that the use node is not the virtual machine, the deployment recommendation server device causes the processing to proceed to S1708.

In S1706, the deployment recommendation server device 130 acquires setting information on a virtual machine, a virtual volume, and an inter-virtual machine virtual network from the environment information request destination, and registers the setting information in the setting information management table 132G.

In S1707, the deployment recommendation server device 130 registers the correspondence between the use node and the virtual machine, the correspondence between the PV and the virtual volume, and the correspondence between the virtual machine and an inter-virtual network virtual network in the configuration information management table 132F.

In S1708, the deployment recommendation server device 130 acquires setting information on the server device 140, the network switch device 170, and the storage device to be used, and registers the setting information in the setting information management table 132G.

In S1709, the deployment recommendation server device 130 registers the correspondence between the use node (virtual machine) and the server device 140, the correspondence between the PVC (PV) and a server-device logical volume or the storage-device logical volume, the correspondence between the server device 140 and the network switch device 170, the correspondence between the storage device and the network switch device 170, the correspondence between the storage-device logical volume and a storage-device volume group, the correspondence between the storage-device volume group and a storage-device physical volume, and the correspondence between the server-device logical volume and a server-device physical volume, in the configuration information management table 132F.

In S1710, the deployment recommendation server device 130 acquires information on an operation information request destination to be used (execution environment of the container, execution environment of the virtual machine, server device 140, and the like), in the computing environment to be used.

In S1711, the deployment recommendation server device 130 determines whether or not S1712 and the subsequent steps have been performed for all operation information request destinations. When it is determined that the steps have been performed, the processing proceeds to S1714. When it is determined that the steps have not been performed, the processing proceeds to S1712.

In S1712, the deployment recommendation server device 130 selects a certain operation information request destination, acquires the operation information, and registers the operation information in the operation information management table 132H. The deployment recommendation server device 130 acquires the operation information when the container is executed, from the execution environment of the container that operates in the hybrid environment, as needed.

In S1713, the deployment recommendation server device 130 waits for the next acquisition trigger.

In S1714, the deployment recommendation server device 130 determines whether or not to end the processing. When it is determined that the processing is to be ended, the deployment recommendation server device ends the information collection processing. When it is determined that the processing is not ended, the deployment recommendation server device causes the processing to proceed to S1713.

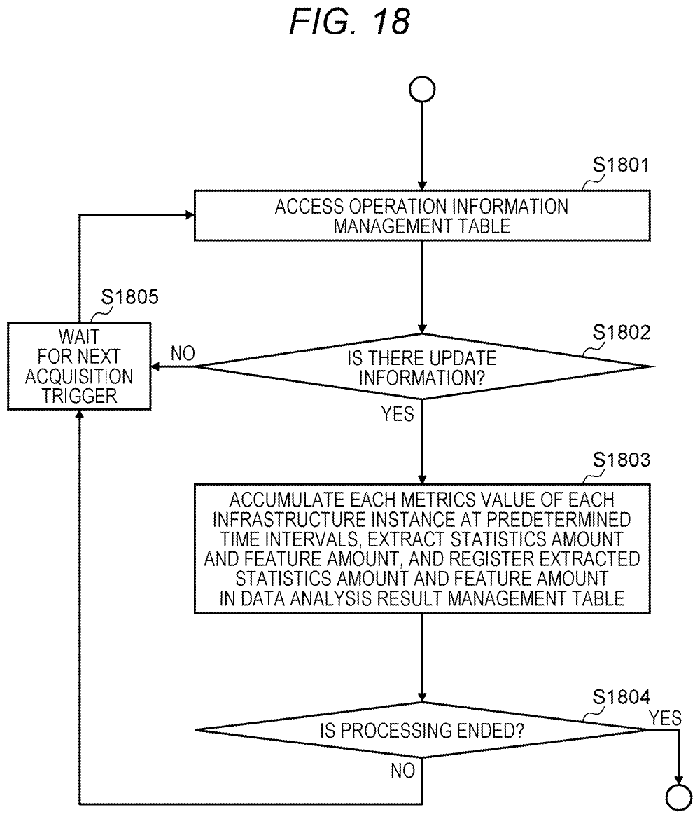

FIG. 18 is a diagram illustrating an example of the data analysis processing.

In S1801, the deployment recommendation server device 130 accesses the operation information management table 132H.

In S1802, the deployment recommendation server device 130 determines whether or not there is update information. When it is determined that there is the update information, the processing proceeds to S1803. When it is determined that there is no update information, the processing proceeds to S1805.

In S1803, the deployment recommendation server device 130 accumulates each metrics value (time-series data) of each infrastructure instance at predetermined time intervals (analysis target time range), and extracts a statistic, and a metrics value of the analysis target time range and/or a feature amount indicating a feature obtained from the statistic. Then, the deployment recommendation server device 130 registers the statistic and the feature amount in the data analysis result management table 132I.

In S1804, the deployment recommendation server device 130 determines whether or not to end the processing. When it is determined that the processing is to be ended, the deployment recommendation server device ends the data analysis processing. When it is determined that the processing is not ended, the deployment recommendation server device causes the processing to proceed to S1805.

In S1805, the deployment recommendation server device 130 waits for the next trigger.

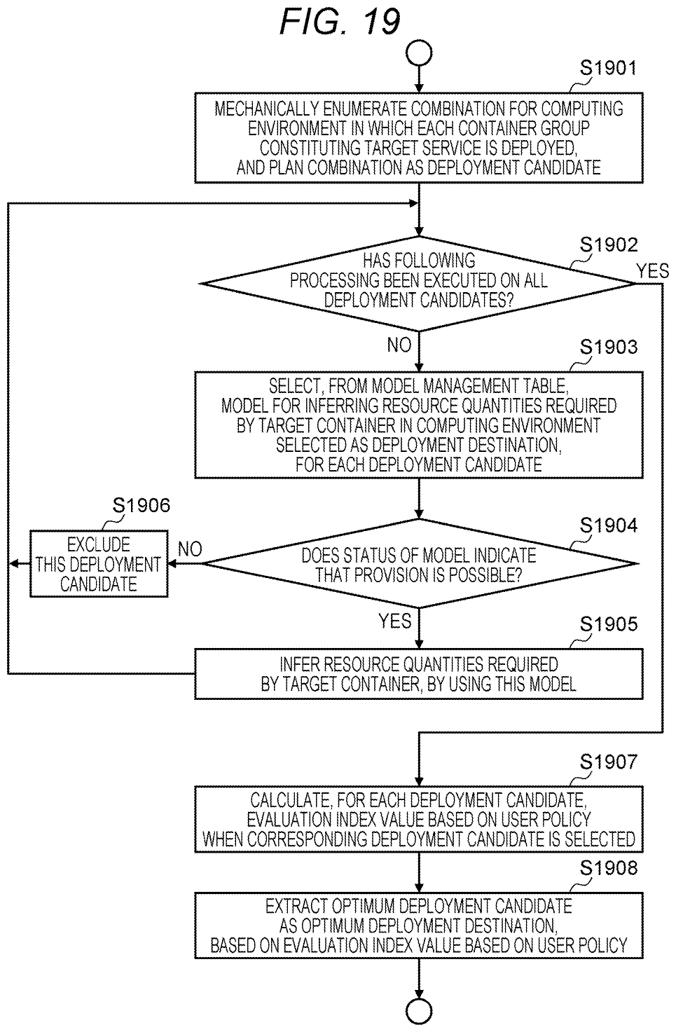

FIG. 19 is a diagram illustrating an example of the optimum deployment destination presentation processing.

In S1901, the deployment recommendation server device 130 mechanically enumerates combinations for the computing environment in which each container group configuring the service (target service) designated by the user is deployed, and plans the combination as a deployment candidate.

In S1902, the deployment recommendation server device 130 determines whether or not S1903 and the subsequent steps have been performed for all deployment candidates. When it is determined that the steps have been performed, the processing proceeds to S1907. When it is determined that the steps have not been performed, the processing proceeds to S1903.

In S1903, the deployment recommendation server device 130 selects, for each deployment candidate, a model for inferring the resource quantity required by a target container in the computing environment selected as the deployment destination, from the model management table 132J.

In S1904, the deployment recommendation server device 130 determines whether or not the status of the model indicates that provision is possible. When it is determined that the status of the model indicates that the provision is possible, the processing proceeds to S1905. When it is determined that the status of the model indicates that the provision is not possible, the processing proceeds to S1906.

In S1905, the deployment recommendation server device 130 uses the model to infer the resource quantity required by the target container.

In S1906, the deployment recommendation server device 130 excludes this deployment candidate.

In S1907, the deployment recommendation server device 130 calculates, for each deployment candidate, an evaluation index value based on the user policy when the deployment candidate is selected. For example, in a case where the user policy refers to cost priority, the deployment recommendation server device 130 calculates how much the inferred usage amount of the CPU will be when the CPU is used in amazon web services (AWS), how much the inferred usage amount will be when the CPU is used in Microsoft Azure, and the like.

In S1908, the deployment recommendation server device 130 extracts an optimum deployment candidate as an optimum deployment destination, based on the evaluation index value based on the user policy. For example, in a case where the user policy refers to cost priority, the deployment recommendation server device 130 extracts a deployment candidate having the lowest cost, as the optimum deployment destination.

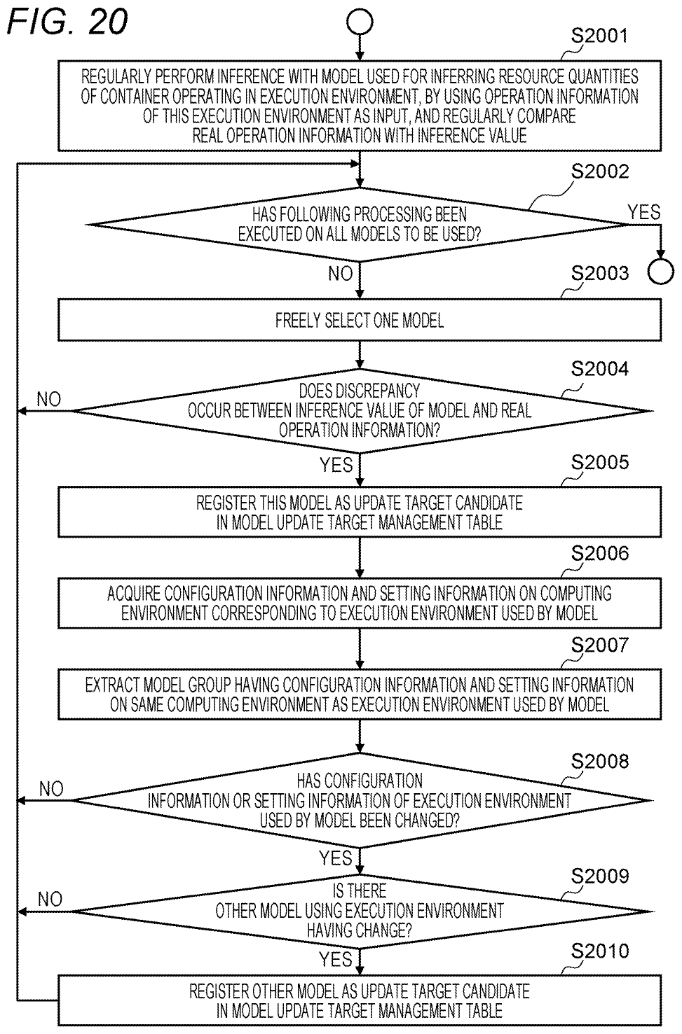

FIG. 20 is a diagram illustrating an example of the model update target selection processing.

In S2001, with the operation information in the execution environment as an input, the deployment recommendation server device 130 regularly performs inference with the model used to infer the resource quantity of the container operated in the execution environment. The deployment recommendation server device 130 regularly compares the real operation information with the inference value.

In S2002, the deployment recommendation server device 130 determines whether or not S2003 and the subsequent steps have been performed for all use models. When it is determined that the steps have been performed, the model update target selection processing is ended. When it is determined that the steps have not been performed, the processing proceeds to S2003.

In S2003, the deployment recommendation server device 130 selects one certain model.

In S2004, the deployment recommendation server device 130 determines whether or not discrepancy occurs between the inference value of the model and the real operation information (whether or not the inference accuracy of the model has decreased). When it is determined that the inference accuracy of the model has decreased, the processing proceeds to S2005. When it is determined that the inference accuracy of the model has not decreased, the processing proceeds to S2002.

In S2005, the deployment recommendation server device 130 registers the model as an update target candidate, in the model update target management table 132L.

In S2006, the deployment recommendation server device 130 acquires configuration information and setting information of a computing environment corresponding to the execution environment used by the model.

In S2007, the deployment recommendation server device 130 extracts a model group having configuration information and setting information of the same computing environment as the execution environment used by the model.

In S2008, the deployment recommendation server device 130 determines whether or not the configuration information or the setting information of the execution environment used by the model has been changed. When it is determined that the change has been made, the processing proceeds to S2009. When it is determined that the change has not been made, the processing proceeds to S2002.

In S2009, the deployment recommendation server device 130 determines whether or not there is another model using the execution environment having the change. When it is determined that there is another model, the processing proceeds to S2010. When it is determined that there is no other model, the processing proceeds to S2002.

In S2010, the deployment recommendation server device 130 registers the other model as an update target candidate, in the model update target management table 132L.

The model update target selection processing is not limited to the above-described processing. For example, the deployment recommendation server device 130 may detect a computing environment in which the configuration information and/or the setting information of the computing environment has been changed, without checking whether or not the inference accuracy of the model has decreased, and may select a model associated with the detected computing environment as the update target candidate.

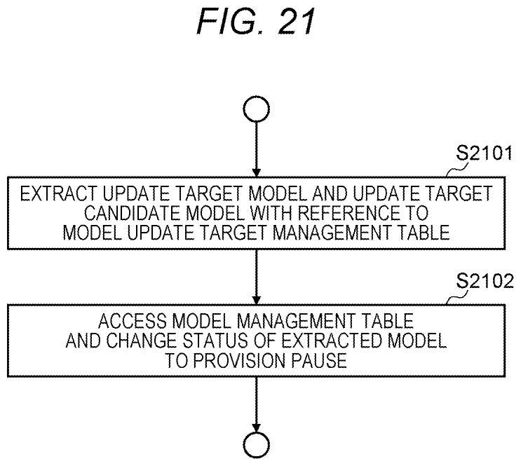

FIG. 21 is a diagram illustrating an example of the model provision pause processing.

In S2101, the deployment recommendation server device 130 refers to the model update target management table 132L, and extracts a model being the update target and a model being the update target candidate.

In S2102, the deployment recommendation server device 130 accesses the model management table 132J and changes the status of the extracted model to the provision pause.

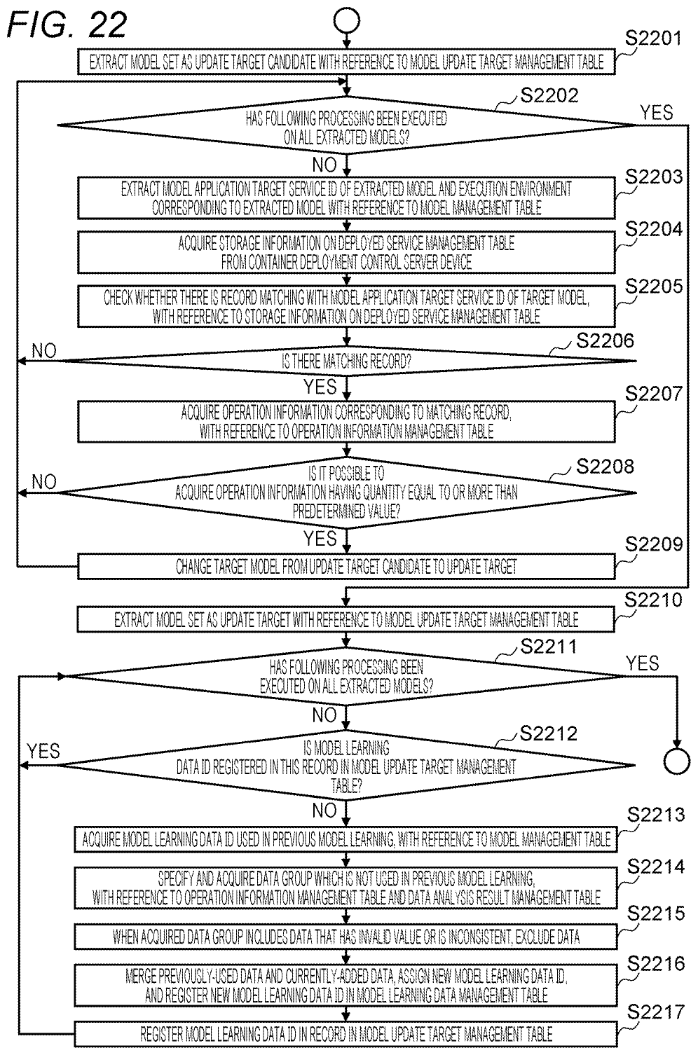

FIG. 22 is a diagram illustrating an example of the model update target check processing.

In S2201, the deployment recommendation server device 130 refers to the model update target management table 132L and extracts a model as the update target candidate.

In S2202, the deployment recommendation server device 130 determines whether or not S2203 and the subsequent steps have been performed for all extracted models. When it is determined that the steps have been performed, the processing proceeds to S2210. When it is determined that the steps have not been performed, the processing proceeds to S2203.

In S2203, the deployment recommendation server device 130 refers to the model management table 132J, and extracts the model application target service ID of the extracted model (target model) being a processing target and the execution environment corresponding to the target model.

In S2204, the deployment recommendation server device 130 acquires the storage information of the deployed-service management table 162C from the container deployment control server device 160.

In S2205, the deployment recommendation server device 130 refers to the storage information of the deployed-service management table 162C, and checks whether there is a record matching with the model application target service ID extracted in S2203.

In S2206, when it is determined that there is a matching record, the deployment recommendation server device 130 causes the processing to proceed to S2207. When it is determined that there is no matching record, the deployment recommendation server device 130 causes the processing to proceed to S2202.

In S2207, the deployment recommendation server device 130 refers to the operation information management table 132H and acquires the operation information corresponding to the matching record.

In S2208, the deployment recommendation server device 130 determines whether or not it is possible to acquire the operation information having a quantity which is equal to or more than a predetermined value. When it is determined that it is possible to acquire the operation information, the processing proceeds to S2209. When it is determined that it is not possible to acquire the operation information, the processing proceeds to S2202.

In S2209, the deployment recommendation server device 130 changes the target model from the update target candidate to the update target.

In S2210, the deployment recommendation server device 130 refers to the model update target management table 132L and extracts a model as the update target.

In S2211, the deployment recommendation server device 130 determines whether or not S2212 and the subsequent steps have been performed for all extracted models. When it is determined that the steps have been performed, the model update target check processing is ended. When it is determined that the steps have not been performed, the processing proceeds to S2212.

In S2212, the deployment recommendation server device 130 determines whether or not the model learning data ID has been registered in the record of the model update target management table 132L. When it is determined that the model learning data ID has been registered, the processing proceeds to S2211. When it is determined that the model learning data ID has not been registered, the processing proceeds to S2213.

In S2213, the deployment recommendation server device 130 refers to the model management table 132J and acquires the model learning data ID used in the previous model learning.

In S2214, the deployment recommendation server device 130 refers to the operation information management table 132H and the data analysis result management table 132I, and specifies and acquires a data group not used in the previous model learning.

In S2215, when the acquired data group includes an invalid value, unmatched data, or the like, the deployment recommendation server device 130 excludes such data.

In S2216, the deployment recommendation server device 130 merges the previous use data and the currently-added data, assigns a new model learning data ID, and registers the new model learning data ID in the model learning data management table 132M.

In S2217, the deployment recommendation server device 130 registers the model learning data ID in the record of the model update target management table 132L.

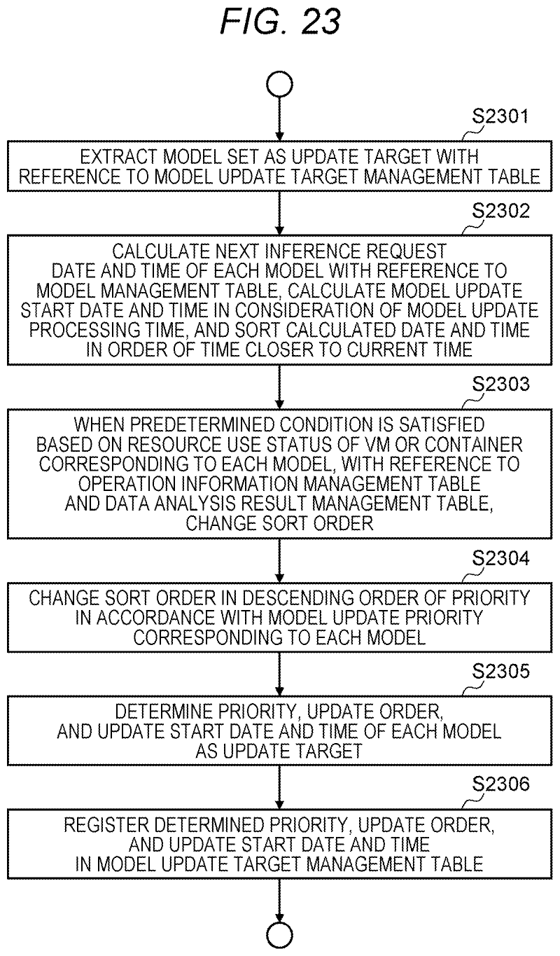

FIG. 23 is a diagram illustrating an example of the model update order setting processing.

In S2301, the deployment recommendation server device 130 refers to the model update target management table 132L and extracts a model as the update target.

In S2302, the deployment recommendation server device 130 refers to the model management table 132J, calculates the next inference request date and time of each model, calculates the model update start date and time in consideration of the update processing time of the model, and sorts the calculated date and times in order from the current time. Thus, the model is updated until the date and time when inference by the model is requested.

In S2303, the deployment recommendation server device 130 refers to the operation information management table 132H and the data analysis result management table I. When a predetermined condition indicating that there is a possibility of having an adverse influence on the inference (a variation range of the resource use is equal to or greater than a threshold value, or the like) is satisfied, based on the resource use status of the VM or the container corresponding to the each model, the deployment recommendation server device 130 changes the sort order so that the model satisfying the predetermined condition is preferentially updated.

In S2304, the deployment recommendation server device 130 changes the sort order in descending order of priority in accordance with the model update priority corresponding to each model.

In S2305, the deployment recommendation server device 130 determines the priority, the update order, and the update start date and time of each model being the update target.

In S2306, the deployment recommendation server device 130 registers the determined priority, update order, and update start date and time in the model update target management table 132L.

The model update order setting processing is not limited to the above details. Any one of S2302 to S2304 may be performed to determine the update order (update date and time), or two or more may be freely combined to determine the update order.

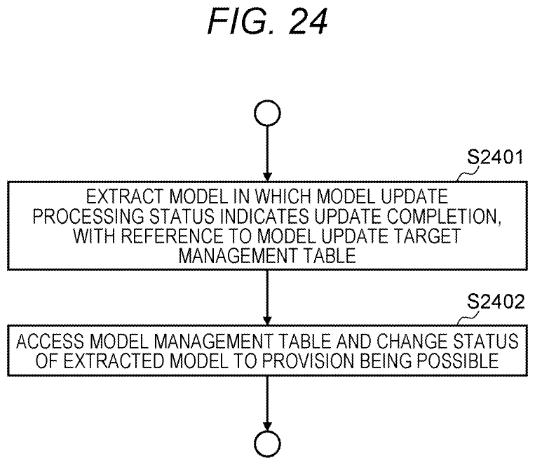

FIG. 24 is a diagram illustrating an example of the model provision resumption processing.

In S2401, the deployment recommendation server device 130 refers to the model update target management table 132L and extracts a model having a model update processing status indicates update completion.

In S2402, the deployment recommendation server device 130 accesses the model management table 132J and changes the status of the extracted model to be that the provision is possible.

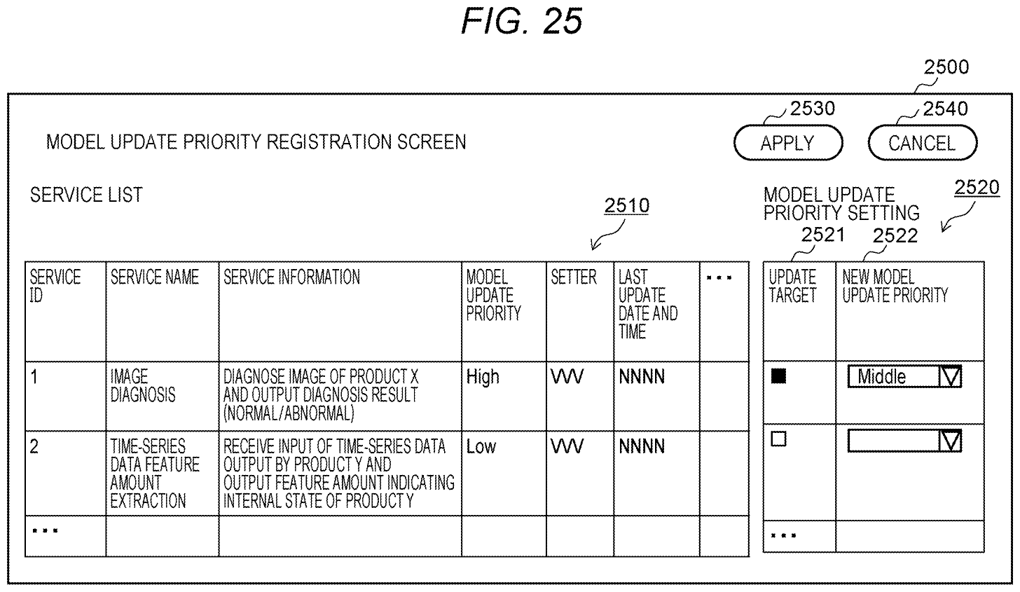

FIG. 25 is a diagram illustrating an example of a model update priority registration screen 2500.

The model update priority registration screen 2500 includes a service list display area 2510 and a model update priority setting area 2520.

In the service list display area 2510, information on the registered service is displayed based on the service management table 112B in the service ID, the service name, and the service information, and information on the previously-registered priority is displayed based on the model update priority management table 132K in the model update priority, the setter, and the last update date and time.

In the model update priority setting area 2520, with the input device, the user puts a check to an update target 2521, selects the priority from a drop list of a new model update priority 2522, and presses an apply button 2530 to set the priority. The user presses a cancel button 2540 to cancel the input to the update target 2521 and the new model update priority 2522.

According to the present embodiment, it is possible to appropriately update the model capable of inferring the resource quantity when the application operates in the resource of the computing environment.

### (II) Appendix

The above-described embodiment includes, for example, the following contents.

In the above-described embodiment, the case where the present invention is applied to the model management system has been described, but the present invention is not limited thereto, and can be widely applied to other various systems, apparatuses, methods, and programs.

In the above-described embodiment, a portion or the entirety of the program may be installed from a program source onto a device such as a computer that realizes the deployment recommendation server device. The program source may be, for example, a program distribution server connected by a network or a computer-readable recording medium (for example, a non-transitory recording medium). In the above description, two or more programs may be implemented as one program, or one program may be implemented as two or more programs.

In the above-described embodiment, the configuration of each table is an example, and one table may be divided into two or more tables, or all or some of two or more tables may be made to be one table.

Further, in the above-described embodiment, for convenience of description, the information related to the model management system has been described using the table, but the data structure is not limited to the table. The information related to the model management system may be expressed by a data structure other than a table, such as an extensible markup language (XML), a YAML Ain′t a markup language (YAML), a hash table, or a tree structure.

In the above-described embodiment, the screen illustrated and described is an example, and any design may be used as long as the received information is the same.

Furthermore, in the above-described embodiment, the screen illustrated and described is an example, and may have any design as long as information to be presented is the same.

In the above-described embodiment, the output of information is not limited to display on a display. The output of the information may be an audio output by a speaker, may be an output to a file, may be printing on a paper medium or the like by a printing device, may be projection on a screen or the like by a projector, or may be another form.

In the above description, information such as a program, a table, and a file, that realizes each function can be stored in a memory, a storage device such as a hard disk and a solid state drive (SSD), or a recording medium such as an IC card, an SD card, and a DVD.

The above-described embodiment has, for example, the following characteristic configurations.

(1)

There is provided a model management system (for example, model management system 100) that manages, for each computing environment and each service, a model capable of inferring a resource quantity when an application (container, VM, or the like) configuring a service to be provided to a user operates, in a resource (CPU 141, memory 142, external recording device 143, network I/F 144, network switch device 170, and the like) of the computing environment in order to determine whether to assign the application to one computing environment among a plurality of computing environments (edge environment, on-premises environment, public cloud environment, and the like). The model management system includes an acquiring unit (for example, information collecting unit 132A, circuit, and deployment recommendation server device 130) that acquires environment information including at least one of configuration information and setting information of the computing environment from each of the plurality of computing environments, a detecting unit (for example, model update managing unit 132E, model update target selecting unit 132E2, circuit, and deployment recommendation server device 130) that detects the computing environment in which the environment information acquired by the acquiring unit has been changed, and a selecting unit (for example, model update managing unit 132E, model update target selecting unit 132E2, circuit, and deployment recommendation server device 130) that selects a model associated with the computing environment detected by the detection unit, as an update target candidate.

According to the above configuration, the model associated with the computing environment in which the environment information has been changed is selected as the update target candidate. Thus, it is possible to efficiently update a model in which the inference accuracy may decrease, for example.

(2)

The acquiring unit acquires operation information of an application deployed in each computing environment, from each of the plurality of computing environments (see S317, for example). The detecting unit detects a model having inference accuracy which is lower than a threshold value, from the operation information of the application, which is acquired by the acquiring unit, and a result of an inference by a model used for assigning the application, and, when environment information of a computing environment associated with the detected model has been changed, the detecting unit detects the computing environment, and the selecting unit selects, as the update target candidates, the model detected by the detecting unit and another model associated with the computing environment (see S2004 to S2010, for example).

According to the above configuration, for example, a model having decreased inference accuracy and another model in the same computing environment as the model are selected as the update target candidates. Thus, it is possible to efficiently update the model having the decreased inference accuracy and the model having a high possibility of a decrease in inference accuracy.

(3)

The model management system further includes a storing unit (for example, model update managing unit 132E, model learning data preparing unit 132E3, circuit, the deployment recommendation server device 130) that stores operation information of the application acquired by the acquiring unit, as learning data to be used to update a model used for assignment of the application, an extracting unit (for example, model update managing unit 132E, model update target selecting unit 132E2, model learning data preparing unit 132E3, circuit, and deployment recommendation server device 130) that extracts, as an update target, a model in which a quantity of learning data stored by the storing unit is equal to or more than a predetermined quantity, among models selected as the update target candidates by the selecting unit, and an updating unit (for example, model managing unit 132B, circuit, and deployment recommendation server device 130) that updates a model extracted as the update target by the extracting unit, by using the learning data of the model stored by the storing unit.

According to the above configuration, for example, the model for which the learning data is prepared is extracted as the update target among the update target candidate models, and updated. Thus, it is possible to efficiently update the model.

(4)

The model management system further includes a setting unit (for example, model update managing unit 132E, circuit, and deployment recommendation server device 130) that sets an order in which the updating unit updates the model extracted as the update target by the extracting unit, based on update order information (for example, operation information management table 132H, data analysis result management table I, model management table 132J, and model update priority management table 132K) including information regarding an order in which the updating unit updates the model. The updating unit updates the model in accordance with the order set by the setting unit (see, for example, S408 and S409).

According to the above configuration, it is possible to update the model in accordance with the update order information defined in advance.

(5)

The update order information includes information (for example, operation information management table 132H and data analysis result management table I) indicating a use status of a resource of each computing environment. The setting unit sets the order from the use status of a resource of a computing environment associated with the model extracted as the update target by the extracting unit, so that a model associated with a computing environment that has an adverse influence on an inference is preferentially updated (see S2303, for example).

According to the above configuration, it is possible to preferentially update the model associated with the computing environment that has an adverse influence on inference, for example.

(6)

The update order information includes information (for example, model update priority management table 132K) indicating a priority of a service provided to a user, the priority being designated by the user, and the setting unit sets the order in which the updating unit updates the model extracted as the update target by the extracting unit, in accordance with the priority (see S2304, for example).

According to the above configuration, it is possible to preferentially update the model having a high priority designated by the user, for example.

(7)

The update order information includes information (for example, model management table 132J) indicating a time interval at which an inference by each model is requested and information indicating an update time taken to update each model. The setting unit calculates date and time at which update of the model is started from a time interval and an update time of the model extracted as the update target by the extracting unit, and sets an order in which the update is performed by the updating unit in accordance with the calculated date and time (S2302, for example).

According to the above configuration, for example, it is possible to update the model while avoiding a time in which inference by the model is required.

(8)

The model management system further includes a determining unit (for example, optimum deployment calculating unit 132D, circuit, and deployment recommendation server device 130) that determines a computing environment in which an application configuring a service provided to a user is deployed, by using a result of an inference by a model that is not selected by the selecting unit among models associated with the service, when the application is deployed in the computing environment.

According to the above configuration, for example, when the computing environment in which the application is deployed is determined, the result of the inference by the model in which the inference accuracy is decreased and the result of the inference by the model in which the inference accuracy may be decreased are not used. Thus, it is possible to more appropriately determine the deployment destination.

In addition, the above-described configuration may be appropriately changed, rearranged, combined, or omitted without departing from the gist of the present invention.

Items included in a list in the format “at least one of A, B, and C” can be understood to mean (A), (B), (C), (A and B), (A and C), (B and C), or (A, B, and C). Similarly, items listed in the format “at least one of A, B, or C” can mean (A), (B), (C), (A and B), (A and C), (B and C), or (A, B, and C).

What is claimed is:

1. A model management system that manages, for each computing environment and each service, a model capable of inferring a resource quantity when an application configuring a service to be provided to a user operates, in a resource of the computing environment, in order to determine whether to assign the application to one computing environment among a plurality of computing environments, the model management system comprising:
an acquiring unit that acquires environment information including at least one of configuration information and setting information of the computing environment from each of the plurality of computing environments;
a detecting unit that detects the computing environment in which the environment information acquired by the acquiring unit has been changed; and
a selecting unit that selects, as an update target candidate, a model associated with the computing environment detected by the detecting unit.

2. The model management system according to claim 1, wherein
the acquiring unit acquires operation information of an application deployed in each computing environment, from each of the plurality of computing environments,
the detecting unit
detects a model having inference accuracy which is lower than a threshold value, from the operation information of the application, which is acquired by the acquiring unit, and a result of an inference by a model used for assigning the application, and
when environment information of a computing environment associated with the detected model has been changed, detects the computing environment, and
the selecting unit selects, as the update target candidates, the model detected by the detecting unit and another model associated with the computing environment.

3. The model management system according to claim 2, further comprising:
a storing unit that stores the operation information of the application, which is acquired by the acquiring unit, as learning data to be used to update the model used for assigning the application;
an extracting unit that extracts, as an update target, a model in which a quantity of learning data stored by the storing unit is equal to or more than a predetermined quantity, from the models selected as the update target candidate by the selecting unit; and
an updating unit that updates the model extracted as the update target by the extracting unit, by using the learning data of the model, which is stored by the storing unit.

4. The model management system according to claim 3, further comprising:
a setting unit that sets an order in which the updating unit updates the model extracted as the update target by the extracting unit, based on update order information including information regarding an order of update of the model by the updating unit, wherein
the updating unit updates the model in accordance with the order set by the setting unit.

5. The model management system according to claim 4, wherein
the update order information includes information indicating a use status of a resource of each computing environment, and
the setting unit sets the order from the use status of a resource of a computing environment associated with the model extracted as the update target by the extracting unit, so that a model associated with a computing environment that has an adverse influence on an inference is preferentially updated.

6. The model management system according to claim 4, wherein
the update order information includes information indicating a priority of a service provided to a user, the priority being designated by the user, and
the setting unit sets the order in which the updating unit updates the model extracted as the update target by the extracting unit, in accordance with the priority.

7. The model management system according to claim 4, wherein
the update order information includes information indicating a time interval at which an inference by each model is requested and information indicating an update time taken to update each model, and
the setting unit
calculates date and time at which update of the model is started from a time interval and an update time of the model extracted as the update target by the extracting unit, and
sets an order in which the update is performed by the updating unit in accordance with the calculated date and time.

8. The model management system according to claim 1, further comprising:
a determining unit that determines a computing environment in which an application configuring a service provided to a user is deployed, by using a result of an inference by a model that is not selected by the selecting unit among models associated with the service, when the application is deployed in the computing environment.

9. A model management method of managing, for each computing environment and each service, a model capable of inferring a resource quantity when an application configuring a service to be provided to a user operates, in a resource of the computing environment, in order to determine whether to assign the application to one computing environment among a plurality of computing environments, the model management method comprising:
by an acquiring unit, acquiring environment information including at least one of configuration information and setting information of the computing environment from each of the plurality of computing environments;
by a detecting unit, detecting the computing environment in which the environment information acquired by the acquiring unit has been changed; and
by a selecting unit, selecting, as an update target candidate, a model associated with the computing environment detected by the detecting unit.
